(19) United States
(12) Patent Application Publication
(10) Pub. No.: US 2008/0111514 A1
(43) Pub. Date: May 15, 2008

(54) Servo Control Apparatus

(75) Inventors: Seitaro Ohta, Kitakyushu-shi (JP); Hiroshi Nakamura, Kitakyushu-shi (JP); Atsushi Imadu, Kitakyushu-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KABUSHIKI KAISHA YASKAWA DENKI, Kitakyushu-shi, Fukuoka (JP)

(21) Appl. No.: 10/587,391

(22) PCT Filed: Dec. 17, 2004
(86) PCT No.: PCT/JP04/18891

§ 371 Date: Jan. 29, 2008

(30) Foreign Application Priority Data
Jan. 28, 2004 (JP) 2004-019652

(51) Int. Cl. G05B 11/36

(52) U.S. Cl. 318/609; 318/632

(57) ABSTRACT

A servo control apparatus improved in trackability without being accompanied by overshoots or any continuous vibration and capable of tracking without any delay from an upper order command is provided. A command signal is directly transmitted to a controller as a target command increment value. A compensation signal arithmetic unit receives the target command increment value, subtracts the target command increment value from a signal having passed through an inverse transfer function unit having an inverse transfer function characteristic of any low-pass filter, and sends a compensation signal generated by multiplying a result of that subtraction by an adjustment gain to a controlled object. The controller receives the target command increment value and an output increment value of the controlled object, and sends a control input to the controlled object so that the output of the target command becomes coincident with the target command.

### FIELD OF THE INVENTION

The present invention relates to a servo control apparatus for driving, e.g., a machine tool, a semiconductor producing equipment, or a mounting apparatus, which require high command trackability.

### BACKGROUND OF THE INVENTION

A servo control apparatus which gives a control input to a controlled object to make an output of the controlled object coincide with the targeted value of the control input, is known (see Japanese Patent No. 3175877 ('877 patent), International Laid-open Patent Publication No. WO93/20489 ('489 patent).)

FIG. 10 is a block diagram showing a structure of a servo control apparatus disclosed by the '877 patent. This is a motor control apparatus which includes a predictive controller 61 and a controlled object 1, and the controlled object 1 includes a motor controller 3 and a motor 2. The output of the predictive controller 61 and the output of the motor 2 are inputted into the motor controller 3, and a target command increment value and an output of the motor are inputted into the predictive controller 61. The motor controller 3 drives the motor 2 while controlling the operation of the motor 2 in response to the control input.

FIG. 11 is a block diagram showing the structure of the predictive controller 61 for the servo control apparatus.

The predictive controller 61 is equipped with memories 62 to 65, an arithmetic unit 66, a subtracter 67, and an integrator 68. A differentiator 69 is connected to the preceding stage thereof. At the current time i·Ts (hereinafter referred to as “Time i”. Ts: Sampling period), when the predictive controller 61 receives an output of the differentiator 69 to which an output y(i−K) of the controlled object of a K (K≧O) sampling past is inputted and the target command increment value Δr(i+M) of an M sampling future, the controller outputs a control input u(i) so as to make the output of the controlled object coincide with the target command.

The memory 62 stores a plurality of sampled target command increment values, and the memory 63 stores constants E, V_{-K+1}, . . . , V_{M}, p₀, . . . P_{Na-1}, g₁ . . . , g_{Nb+K-1} for control. Furthermore, the memory 64 stores a plurality of sampled output increment values, and the memory 65 stores a plurality of sampled control inputs.

The subtracter 67 subtracts the output increment value Δy(i−K) which is an output of the differentiator 69 from the target command increment value Δr(i−K) of the K sampling past, and then the integrator 68 integrates the outputs to obtain the error e(i-K).

The arithmetic unit 66 obtains a control input u(i) by Expression (1) so that an evaluation function on a future error predictive value calculated using the transfer function model from the control input to the output of the controlled object, the error, and the control input becomes minimum.

$$\begin{matrix}[ Formula 1 ] & \\ u ( i ) = {\sum }_{m = - K + 1}^{M} {v}_{m} Δ r ( i + m ) - {\sum }_{n = 0}^{Na - 1} {p}_{n} Δ y ( i - K - n ) + Ee ( i - K ) - {\sum }_{n = 1}^{Nb + K - 1} {g}_{n} u ( i - n ) & ( 1 )\end{matrix}$$

With this structure, since the control input is determined so that the future error predictive value becomes minimum, a servo control apparatus excellent in trackability can be realized.

Japanese Unexamined Laid-open Patent Publication No. 2002-62906 ('906 patent) proposes a servo control apparatus including a feed-forward signal creation command filter, and teaches that the trackability can be enhanced without deteriorating predictive accuracy even if feed-forward control is performed. Furthermore, the present applicant proposed a servo control apparatus including a compensation signal arithmetic unit improved in trackability at the time of changing the speed and/or the acceleration.

FIG. 12 is a block diagram showing a structure of a compensation signal arithmetic unit used for the servo control apparatus proposed by the present applicant.

The compensation signal arithmetic unit 100 is equipped with a filter 101, a multiplier 102, a subtracter 103 and phase adjusters 104 and 105, and configured to output a compensation signal and a target command increment value so that the error of the target command and the output of the controlled object at the time of acceleration/deceleration becomes small when a command increment value is inputted. If the compensation signal arithmetic unit 100 receives a command increment value at this time, the phase adjuster 105 performs a phase adjustment, and the filter 101 performs filtering, to output the target command increment value. At the same time, the subtracter 103 subtracts the target command increment value from a signal in which the command increment value is adjusted in phase with the phase adjuster 104, and the multiplier 102 multiplies the output by an adjustment gain to output a compensation signal.

The filter 101 is any low-pass filter selected from a recursive filter and a non-recursive filter.

The phase adjuster 104 and 105 is either a low-pass filter or a high-pass filter, or a delay device for delaying a signal by a time specified by a phase adjustment parameter.

FIG. 13 is a block diagram showing a structure of a servo control apparatus using the predictive controller shown in FIG. 11 and the compensation signal arithmetic unit shown in FIG. 12. The target command increment value of the compensation signal arithmetic unit 100 is inputted into the predictive controller 61. The compensation signal outputted from the compensation signal arithmetic unit 100, the control input outputted from the predictive controller 61 and the output of the controlled object are inputted into a motor controller 3, and the output of the motor 2 is also inputted into the predictive controller 61. The motor controller 3 drives the motor 2 and the operation of the motor 2 is controlled according to the control input.

According to this structure, since the control input of the controlled object 1 is determined so that the future error predicted value becomes minimum, a servo control apparatus with improved trackability can be realized, and therefore even in cases where it is difficult to follow only by a controller due to large changes in speed or acceleration, the compensation signal arithmetic unit compensates the controlled object by a feed-forward compensation signal. As a result, even if a command for sharply changing the speed and/or the acceleration is received, the controlled object 1 can be controlled with improved trackability without causing any overshoots and any continuous vibration.

However, although a conventional servo control apparatus can decrease the error of a target command and a controlled object output, since a signal in which an command increment value is filtered is used as a target command increment value, there was a problem that a delay arose between the command increment value and the target command increment value, resulting in an error of a command and a controlled object output. Moreover, when a command increment value is used as a target command increment value without filtering, although no delay may occur between the command and the target command, a tracking error will occur when speed and/or acceleration changes significantly.

The present invention provides a servo control apparatus capable of decreasing an error of a command and a controlled object output by decreasing a tracking error and further decreasing a delay of a target command to the command even if speed and/or acceleration changes sharply.

### SUMMARY OF THE INVENTION

In order to attain the above-mentioned objects, according to a servo control apparatus according to the present invention, a servo control apparatus for controlling a controlled object in response to a command, includes a controller which receives a target command increment value which is an increment in a sampling period of a target command, and sends a control input to the controlled object such that the target command which is an integrated value of the target command increment value becomes coincident with an output of the controlled object and a compensation signal arithmetic unit which receives the target command increment value as an input, generates a compensation signal for decreasing an error of the target command and the output of the controlled object at the time of acceleration/deceleration, and sends the compensation signal to the controlled object.

According to this invention, in accordance with the target command increment value, the controller controls the controlled object, the target command increment value is subtracted from the output of the inverse transfer unction unit having an inverse transfer function characteristic of a standard low-pass filter which receives the target command increment value, and the compensation signal arithmetic unit compensates the signal in which an adjustment gain is multiplied by the output of the subtracter by the feed-forward compensation signal to the controlled object.

Furthermore, the compensation signal arithmetic unit can include a differentiator which differentiates the target command increment value, and a multiplier which multiplies an output of the differentiator by an adjustment gain, to thereby output the output of the differentiator as a feed-forward compensation signal.

Furthermore, the compensation signal arithmetic unit can be equipped with a phase adjuster for performing a phase adjustment of an output of the multiplier.

Furthermore, the compensation signal arithmetic unit can be equipped with a phase adjuster at least one of the inputs of the subtracter.

Furthermore, the servo control apparatus can further comprises a phase adjuster which sends a signal in which a phase adjustment of the target command increment value is performed to the controller.

Furthermore, the controller can be a predictive controller which determines the control input such that an evaluation function on an error predicted value at a future time, an error, a control input, and a control input increment value becomes minimum. Alternatively, the controller can be a position controller which adjusts the control input so that the target command obtained by integrating the target command increment value becomes coincident with the output of the controlled object.

Furthermore, the controlled object can include a motor and a speed controller for controlling its speed, wherein the controller gives a speed command as a control input to the speed controller, and wherein the compensation signal arithmetic unit gives a feed-forward signal for compensating speed or torque as a compensation signal to the speed controller.

Furthermore, the controlled object can include a motor and a torque controller for controlling torque of the motor, wherein the controller gives a torque command to the torque controller as a control input, and wherein a compensation signal arithmetic unit gives a feed-forward signal for compensating torque as a compensation signal to the torque controller.

Furthermore, the motor can be a straight-moving type motor.

Furthermore, the phase adjuster can be any one of a low-pass filter, a high-pass filter, and a delay device for delaying a signal by a time specified by a phase adjustment parameter.

Furthermore, the standard low-pass filter can be either a recursive filter or a non-recursive filter.

Furthermore, the position controller can decide the control input by the target command obtained by integrating the target command increment value, any one of proportionality, integral and differential operation of an error with a position of the motor, or a combination thereof.

According to one aspect of the present invention, a compensation signal for compensating so that the error of the target command and the output of the controlled object at the time of the acceleration/deceleration change becomes small is generated and sent to the controlled object. Therefore, there is an effect that the controlled object can be controlled at high traceability even if speed and/or acceleration changes sharply.

According to another aspect of the present invention, the compensation signal arithmetic unit which generates a compensation signal for compensating so that the error of the target command and the output of the controlled object at the time of acceleration/deceleration changes becomes small receives the target command increment value, subtracts the target command increment value from the output of the inverse transfer function unit having an inverse transfer function characteristic of an arbitrarily decided low-pass filter arbitrarily, and sends the signal in which an adjustment gain is multiplied to the controlled object as a compensation signal. Therefore, there is an effect that the controlled object can be controlled at high trackability even if speed and/or acceleration changes sharply.

According to another aspect of the present invention, the compensation signal arithmetic unit which generates a compensation signal for compensating so that the error of the target command and the output of the controlled object at the time of acceleration/deceleration changes becomes small sends a signal in which a signal differentiated target command increment value is multiplied by an adjustment gain as a compensation signal to the controlled object. Therefore, there is an effect that the controlled object can be controlled at high trackability even if speed and/or acceleration changes sharply.

According to another aspect of the present invention, the phase adjuster is provided at the output of the compensation signal arithmetic unit which generates a compensation signal for compensating so that the error of the target command and the output of the controlled object at the time of acceleration/deceleration changes becomes small, and a compensation signal is sent to the controlled object after the phase adjustment. Therefore, there is an effect that the controlled object can be controlled at high trackability even if speed and/or acceleration changes sharply.

According to another aspect of the present invention, the compensation signal arithmetic unit which generates a compensation signal for compensating so that the error of the target command and the output of the controlled object at the time of acceleration/deceleration changes becomes small receives the target command increment value, performs a phase adjustment of the target command increment value or the output of the inverse transfer function unit having an inverse transfer function characteristic of an arbitrarily decided low-pass filter, and sends a signal in which an adjustment gain is multiplied to the controlled object as a compensation signal. Therefore, there is an effect that the controlled object can be controlled at high trackability even if speed and/or acceleration changes sharply.

According to another aspect of the present invention, the signal in which the target command increment value is adjusted in phase is inputted into the compensation signal arithmetic unit which generates a compensation signal for compensating so that the error of the target command and the output of the controlled object at the time of acceleration/deceleration changes becomes small as an input signal. Therefore, there is an effect that the controlled object can be controlled at high trackability even if speed and/or acceleration changes sharply.

According to another aspect of the present invention, outputs of the predictive controller which determines the control input so that the evaluation function on the error predicted value, the control input, and the control input increment value at a future time becomes minimum and the compensation signal arithmetic unit which generates a compensation signal for compensating so that the error of the target command and the output of the controlled object at the time of acceleration/deceleration changes becomes small are inputted into the controlled object to control the controlled object. Therefore, there is an effect that the controlled object can be controlled at high trackability even if speed and/or acceleration changes sharply.

According to another aspect of the present invention, outputs of the position controller which determines a control input so that the output of the controlled object becomes coincident with the target command and the compensation signal device which generates the compensation signal for compensating so that the error of the target command and the output of the controlled object becomes small at the time of acceleration/deceleration are inputted into the controlled object to control the controlled object. Therefore, there is an effect that the controlled object can be controlled at high trackability even if speed and/or acceleration changes sharply.

According to another aspect of the present invention, even if the controlled object includes a motor and a speed controller for controlling its speed, a compensation signal for compensating so that the error of the target command and the output of a controlled object at the time of acceleration/deceleration becomes small is generated and sent to the controlled object. Therefore, there is an effect that the controlled object can be controlled at high trackability even if speed and/or acceleration changes sharply.

According to another aspect of the present invention, even if the controlled object includes a motor and a torque controller for controlling its torque, a compensation signal for compensating so that the error of the target command and the output of a controlled object at the time of acceleration/deceleration becomes small is generated and sent to the controlled object. Therefore, there is an effect that the controlled object can be controlled at high trackability even if speed and/or acceleration changes sharply.

According to another aspect of the present invention, even if the motor is a straight-moving type motor, a compensation signal for compensating so that the error of the target command and the output of a controlled object at the time of acceleration/deceleration becomes small is generated and sent to the controlled object. Therefore, there is an effect that the controlled object can be controlled at high trackability even if speed and/or acceleration changes sharply.

According to another aspect of the present invention, even if the phase adjuster is any one of a low-pass filter, a high-pass filter, and a delay device for delaying a signal by a time specified by a phase adjustment parameter, a compensation signal for compensating so that the error of the target command and the output of a controlled object at the time of acceleration/deceleration becomes small is generated and sent to the controlled object. Therefore, there is an effect that the controlled object can be controlled at high trackability even if speed and/or acceleration changes sharply.

According to another aspect of the present invention, the compensation signal arithmetic unit which generates a compensation signal for compensating so that the error of the target command and the output of the controlled object at the time of acceleration/deceleration changes becomes small receives the target command increment value, subtracts the target command increment value from the output of the inverse transfer function unit having an inverse transfer function characteristic of a low-pass filter decided as a recursive filter or a non-recursive filter, and sends the signal in which an adjustment gain is multiplied to the controlled object as a compensation signal. Therefore, there is an effect that the controlled object can be controlled at high trackability even if speed and/or acceleration changes sharply.

According to another aspect of the present invention, even if the controller is a PID controller which decides the control input by any one of proportionality, integral and differential operation of an error of the target command and the position of the motor, or a combination thereof, the compensation signal arithmetic unit which generates a compensation signal for compensating so that the error of the target command and the output of the controlled object at the time of acceleration/deceleration changes becomes small receives the target command increment value, subtracts the target command increment value from the output of the inverse transfer function unit having an inverse transfer function characteristic of an arbitrarily decided low-pass filter arbitrarily, and sends the signal in which an adjustment gain is multiplied to the controlled object as a compensation signal. Therefore, there is an effect that the controlled object can be controlled at high trackability even if speed and/or acceleration changes sharply.

### BRIEF DESCRIPTION OF THE DRAWINGS

A preferred embodiment of the present invention will be described with reference to the accompanying drawing wherein:

FIG. 1 is a block diagram showing a structure of a servo control apparatus according to the present invention;

FIG. 2 is a block diagram showing a structure of a compensation signal arithmetic unit;

FIG. 3 is a block diagram showing a structure of a second compensation signal arithmetic unit;

FIG. 4 is a block diagram showing a structure of a third compensation signal arithmetic unit;

FIG. 5 is a block diagram showing a structure of a fourth compensation signal arithmetic unit;

FIG. 6 is a block diagram showing a structure of a fifth compensation signal arithmetic unit;

FIG. 7 is a block diagram showing a structure of a second servo control apparatus;

FIG. 8 is a block diagram showing a structure of a third servo control apparatus;

FIG. 9 is a block diagram showing a structure of a fourth servo control apparatus;

FIG. 10 is a block diagram showing a structure of a conventional servo control apparatus;

FIG. 11 is a block diagram showing a structure of a predictive controller applied to the conventional servo control apparatus;

FIG. 12 is a block diagram showing a structure of a compensation signal arithmetic unit; and

FIG. 13 is a block diagram showing a structure of a servo control apparatus to which the predictive controller and the compensation controller are applied.

### DETAILED DESCRIPTION OF THE INVENTION

Embodiments of the present invention will be detailed with reference to drawings.

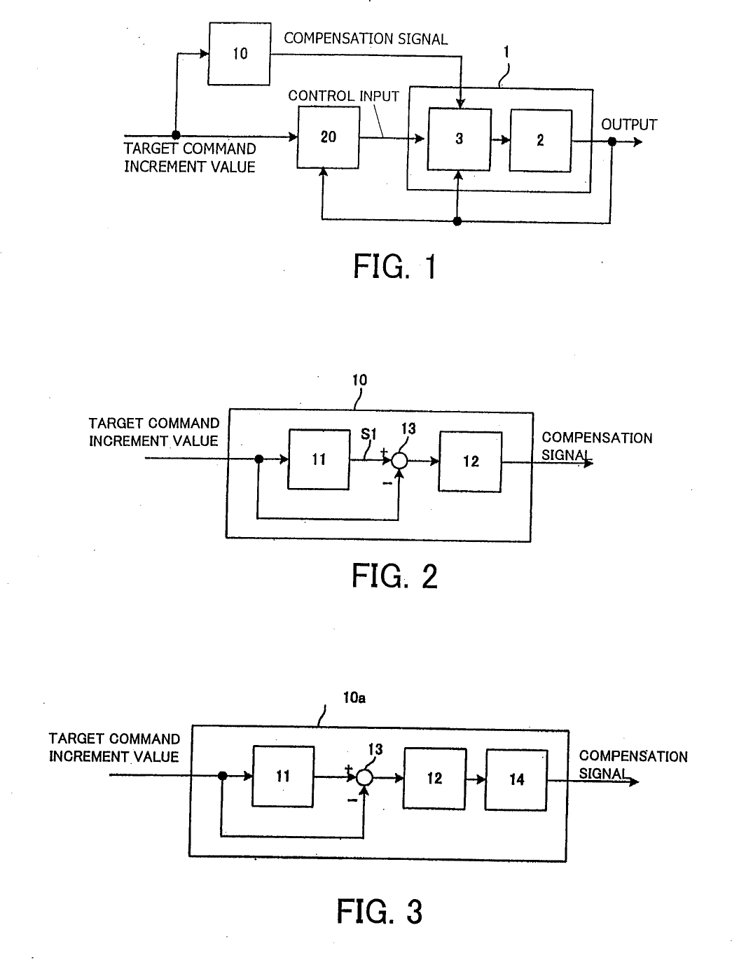

FIG. 1 is a block diagram showing a structure of a servo control apparatus according to the present invention. As shown in this figure, this servo control apparatus is equipped with a compensation signal arithmetic unit 10 and a predictive controller 20 to control a controlled object 1.

The compensation signal arithmetic unit 10 generates a compensation signal based on a target command increment value given from an upstream command device (not illustrated), i.e., an increment value in a sampling period of the target command.

The predictive controller 20 receives the target command increment value and an output of the controlled object 1, performs a predetermined operation to generate a control input, and inputs the control input into the controlled object 1. At this time, the predictive controller 20 determines the control input so as to minimize the evaluation function regarding the error predicted value at a future time, the error, the control input, and the control input increment value.

The predictive controller 20 can be any conventional one as disclosed by the '877 patent, the '489 patent, and the '906 patent mentioned above. This explanation will be directed to an embodiment in which the predictive controller shown in FIG. 11 is used.

In the embodiment shown in FIG. 11, provided that the transfer function model of the controlled object 1 is given by the discrete time system of Gp(z)=(b₁z⁻¹+ . . . +b_{Nb}z^{-Nb})/{(1−z⁻¹)(1−a₁z⁻¹− . . . −a_{Na}z^{-Na}) the output increment value model will be served as Expression (2).

$$\begin{matrix}[ Formula 2 ] & \\ Δ \hat{y} ( i ) = {\sum }_{n = 1}^{Na} {a}_{n} Δ \hat{ y} ( i - n ) + {\sum }_{n = 1}^{Nb} {b}_{n} u ( i - n ) & ( 2 )\end{matrix}$$

In this expression, “Δ” denotes an increment value in a sampling period. At the time i, since an actual measured value Δy(i−n) (n≧K) of the output increment value until the time i−K is obtained, predicting the output increment value thereafter by Expressions (3a) and (3b) using the actual measured value, the output increment value predicted value Δy*(i+m) will be given by Expression (4).

$$\begin{matrix}[ Formula 3 ] & \\ Δ {y}^{*} ( i - K + 1 ) = {\sum }_{n = 1}^{Na} {a}_{n} Δ y ( i - K + 1 - n ) + {\sum }_{n = 1}^{Nb} {b}_{n} u ( i - K + 1 - n ) m = - K + 1 & ( 3 a ) \\ Δ {y}^{*} ( i + m ) = {\sum }_{n = 1}^{m + K - 1} {a}_{n} Δ {y}^{*} ( i + m - n ) + {\sum }_{n = m + K}^{Na} {a}_{n} Δ y ( i + m - n ) + {\sum }_{n = 1}^{Nb} {b}_{n} u ( i + m - n ) m > - K + 1 & ( 3 b ) \\ Δ {y}^{*} ( i + m ) = {\sum }_{n = K}^{Na + K - 1} {A}_{mn} Δ y ( i - n ) + {\sum }_{n = 0}^{Nb + K - 1} {B}_{mn} u ( i - n ) m \geq - K + 1 & ( 4 )\end{matrix}$$

Here, the coefficients Aₘₙ and Bₘₙ will be given by Expressions (5a), (5b), (6a), and (6b), where the future control input is defined by u(j)=0(j>i).

$$\begin{matrix} [ Formula 4 ] & \\ {A}_{( - K + 1 ) n} = {a}_{( n - K + 1 )} \\ m = - K + 1 , K ≦ n ≦ Na + K - 1 & ( 5 a ) \\ {A}_{mn} = {\sum }_{j = 1}^{m + K - 1} {a}_{j} {A}_{( m - j ) n} + {a}_{( n + m )} \\ m > - K + 1 , K ≦ n ≦ Na + K - 1 & ( 5 b ) \\ {B}_{( - K + 1 ) n} = {b}_{( n - K + 1 )} \\ m = - K + 1 , 0 ≦ n ≦ Nb + K - 1 & ( 6 a ) \\ {B}_{mn} = {\sum }_{j = 1}^{m + K - 1} {a}_{j} {B}_{( m - j ) n} + {b}_{( n + m )} \\ m > - K + 1 , 0 ≦ n ≦ Nb + K - 1 & ( 6 b )\end{matrix}$$

where aₙ=0 (n>Na), bₙ=0 (n<1 and n>Nb)

Assuming u(j)=u(i) (j>i), Bₘ₀ of Expression (6b) will be given by Expression (6b′).

$$\begin{matrix}[ Formula 5 ] & \\ \begin{matrix} {B}_{m 0} = 0 & - K + 1 < m \leq 0 \\ {B}_{m 0} = {\sum }_{j = 1}^{m + K - 1} {a}_{j} {B}_{( m - j ) 0} + {\sum }_{j = 1}^{m} {b}_{j} & m \geq 1\end{matrix} \} & ( 6 {b}^{′} )\end{matrix}$$

Giving the future error e*(i+m) by Expression (7) and deciding the control input u(i) so that the evaluation function of Expression (8) becomes minimum, Expression (1) is obtained from ∂J/∂u(i)=0. Each constant, vₘ, pₙ, E, and gₙ are given by Expression (9).

$$\begin{matrix}[ Formula 6 ] & \\ {e}^{*} ( i + m ) = {\sum }_{s = - K + 1}^{m} \{ Δ r ( i + s ) - Δ {y}^{*} ( i + s ) \} + e ( i - K ) 1 \leq m \leq M & ( 7 ) \\ J = {\sum }_{m = 1}^{M} {w}_{m} {\{ {e}^{*} ( i + m ) + α e ( i - K ) \}}^{2} + c {\{ u ( i ) \}}^{2} + {c}_{d} {\{ Δ u ( i ) \}}^{2} & ( 8 ) \\ \begin{matrix} {β}_{s} = {\sum }_{j = 1}^{s} {B}_{j 0} , & W = {\sum }_{s = 1}^{M} {w}_{s} {β}_{s}^{2} + c + {c}_{d} , & {q}_{s} = {w}_{s} {β}_{s} / W \\ {v}_{m} = {\sum }_{s = m}^{M} {q}_{s} & \begin{matrix} m = - K + 1 , - K + 2 , … , M \\ \end{matrix} & \\ E = ( 1 + α ) {v}_{1} & & \\ {p}_{n} = {\sum }_{m = - K + 1}^{M} {v}_{m} {A}_{m ( n + K )} & n = 0 , 1 , … , {N}_{a} - 1 & \\ {g}_{1} = {\sum }_{m = - K + 1}^{M} {v}_{m} {B}_{m 1} - {c}_{ d} / W & n = 1 & \\ {g}_{n} = {\sum }_{m = - K + 1}^{M} {v}_{m} {B}_{mn} & n = 2 , … , {N}_{b} + K - 1 & \end{matrix} \} & ( 9 )\end{matrix}$$

Here, if K=0, the evaluation function of Expression (8) will be given by Expression (10), and the control input u(i) which makes this evaluation function minimum can be obtained by Expression (11).

$$\begin{matrix}[ Formula 7 ] & \\ J = {\sum }_{m = 1}^{M} {w}_{m} {\{ {e}^{*} ( i + m ) + α e ( i ) \}}^{2} + c {\{ u ( i ) \}}^{2} + {c}_{d} {\{ Δ u ( i ) \}}^{2} & ( 10 ) \\ u ( i ) = {\sum }_{m = 1}^{M} {v}_{m} Δ r ( i + m ) - {\sum }_{n = 0}^{Na - 1} {p}_{n} Δ y ( i - n ) + Ee ( i ) - {\sum }_{n = 1}^{Nb - 1} {g}_{n} u ( i - n ) & ( 11 )\end{matrix}$$

The control input outputted by the predictive controller 20, the compensation signal of the compensation signal arithmetic unit 10, and the output of the controlled object are inputted into the motor controller 3, and the output of the motor 2 is also inputted into the predictive controller 20. The motor controller 3 drives the motor 2 and the operation of the motor 2 is controlled according to the control input.

FIG. 2 is a block diagram showing the structure of the compensation signal arithmetic unit 10. This compensation signal arithmetic unit 10 is comprised of an inverse transfer function unit 11, a multiplier 12, and a subtracter 13.

When a target command increment value is inputted, the inverse transfer function unit 11 calculates in accordance with an inverse transfer function characteristic of a previously set standard low-pass filter and outputs a signal S1. After the subtracter 13 subtracts the target command increment value from the signal S1, the multiplier 12 outputs a compensation signal by multiplying Gain K.

According to the present invention, as explained above, the predictive controller 20 controls the controlled object 1 in accordance with the target command increment value, and the difference of the output of the inverse transfer function unit and the target command increment value is multiplied by an adjustment gain to obtain an output of the compensation signal arithmetic unit 10. This output is served as a feed-forward compensation signal of the controlled object 1, enabling a control of the controlled object 1 at high trackability without causing any overshoots or any continuous vibration. Furthermore, no delay of the command to be inputted into the predictive controller 20 occurs.

Although an example of a structure of a compensation signal arithmetic unit is shown in FIG. 2, other structures can be employed. Hereinafter, various modifications will be explained.

FIG. 3 is a block diagram showing a structure of a second compensation signal arithmetic unit. The compensation arithmetic unit 10a shown in FIG. 3 differs from the compensation signal arithmetic unit 10 shown in FIG. 2 in that a compensation signal is obtained after performing the phase adjustment of the output of the multiplier 12.

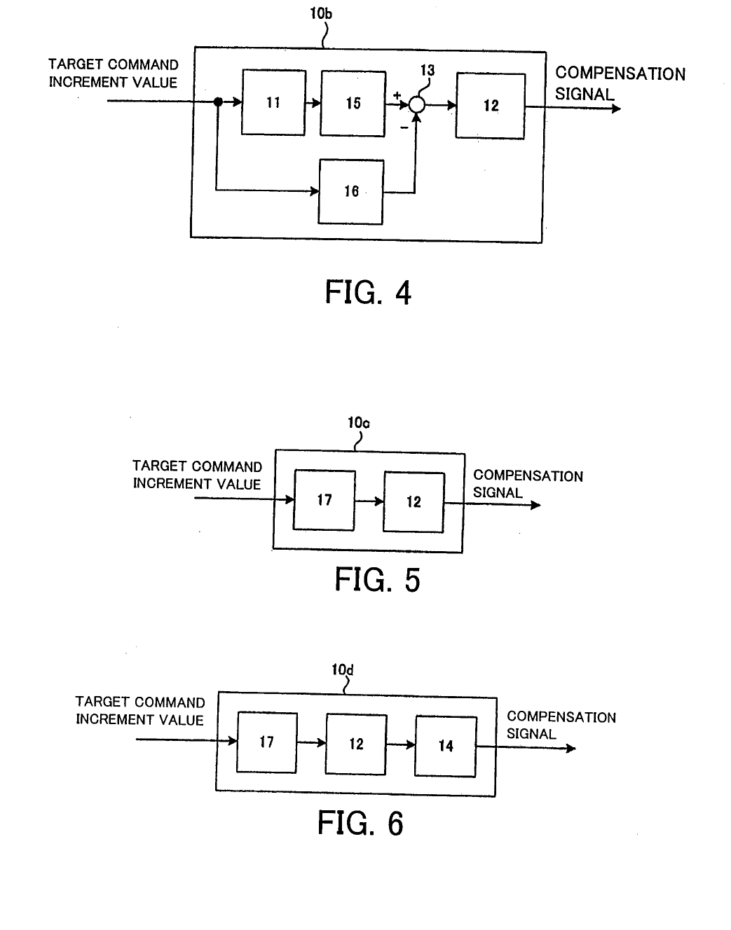

FIG. 4 is a block diagram showing a structure of a third compensation signal arithmetic unit. The compensation arithmetic unit 10b shown in FIG. 4 differs from the compensation signal arithmetic unit 10 shown in FIG. 2 in that phase adjustments of both inputs of the subtracter 13 are performed by phase adjusters 15 and 16. It can be configured such that either one of the two phase adjusters 15 and 16 is provided. Any more effective structure can be employed.

FIG. 5 is a block diagram showing a structure of a fourth compensation signal arithmetic unit, which is configured such that only a differentiator 17 is provided at the preceding stage of the multiplier 12.

The target command increment value inputted into the compensation signal arithmetic unit 10c is differentiated by the differentiator 17 and multiplied by Gain K at the multiplier 12 to serve the compensation signal.

FIG. 6 is a block diagram showing a structure of a fifth compensation signal arithmetic unit in which a phase adjuster 14 is added after the multiplier 12 of the compensation signal arithmetic unit 10c shown in FIG. 5. With this structure, the phase adjustment of the output of the multiplier 12 is performed to serve the compensation signal.

If the motor controller 3 of the controlled object 1 is a speed control device, the control input of the motor controller 3 is a speed command, and the compensation signal is a feed-forward signal which compensates the speed or the torque in the motor controller 3.

If the motor controller 3 of the controlled object 1 is a torque control device, the control input of the motor controller 3 is a torque command, and the compensation signal is a feed-forward signal which compensates the torque in the motor controller 3.

Each phase adjuster 14-16 contained in the compensation signal arithmetic unit 10a, 10b and 10d is either a low-pass filter or a high-pass filter, or a delay device which delays a signal by a time set in the phase adjustment parameter. Any one of them can be arbitrarily selected.

The standard low-pass filter which constitutes the inverse transfer function unit 11 can be either a recursive filter or a non-recursive filter higher in effect.

The phase adjustment value of each phase adjuster 14-16 and the adjustment gain K of the multiplier 12 can be adjusted so that the error of the target command and the controlled object output becomes as small as possible. For example, the adjustment gain K is adjusted so that the error becomes small at the time of accelerating at a constant acceleration, and the phase adjustment value of each phase adjuster 14-16 is adjusted so that the error becomes small when the acceleration is changing.

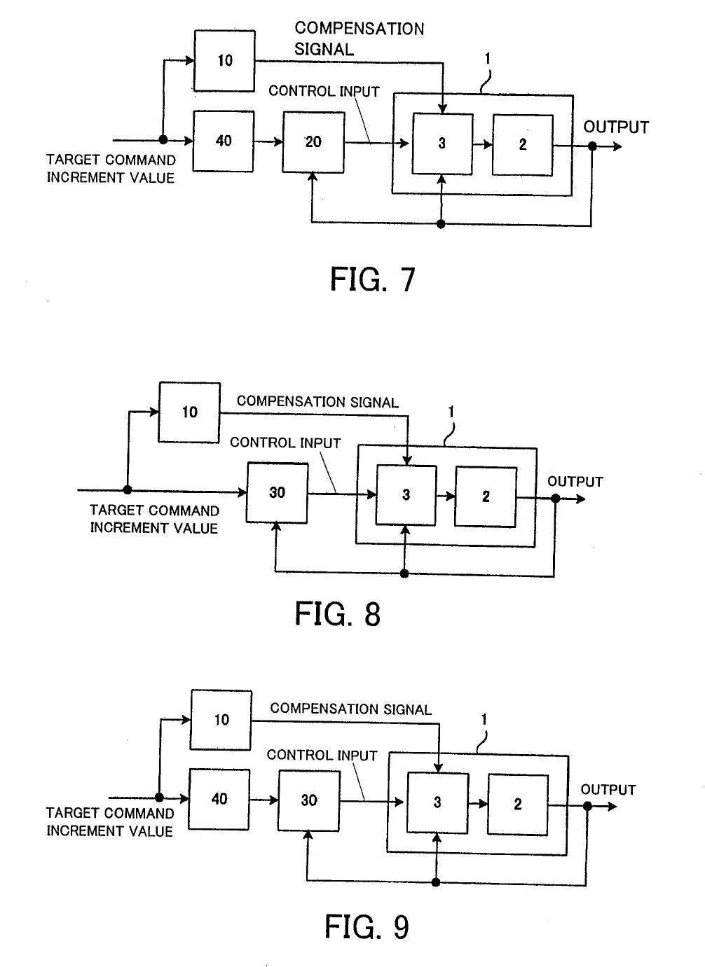

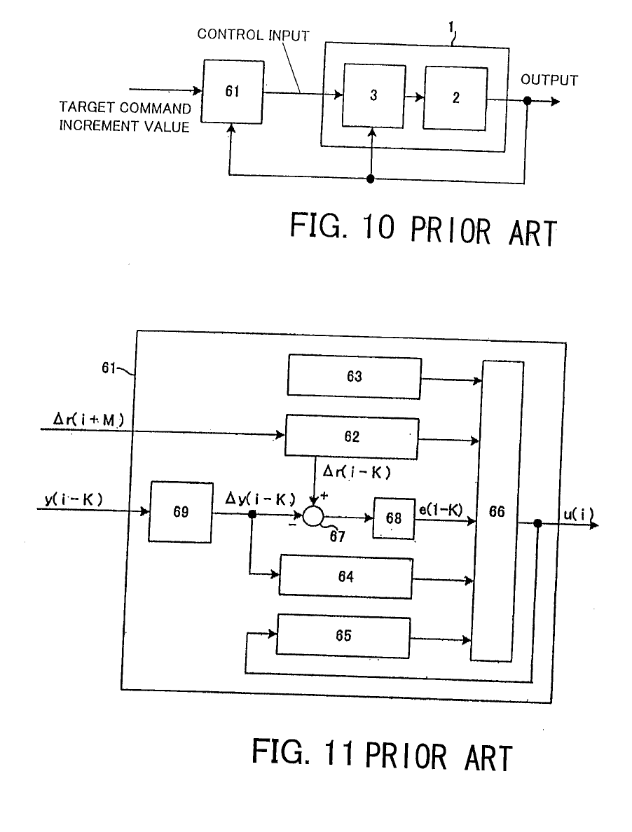

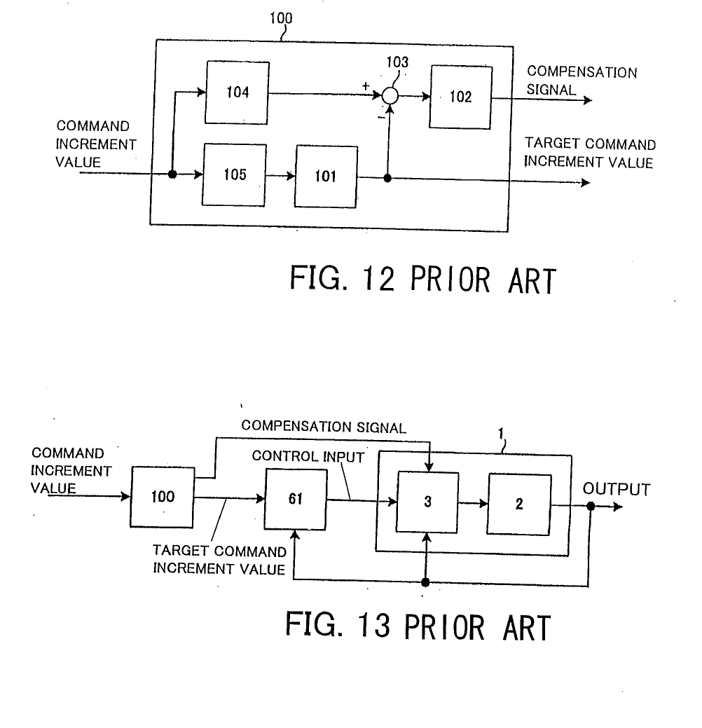

FIG. 7 is a block diagram showing a structure of a second servo control apparatus which differs from the apparatus shown in FIG. 1 in that a phase adjuster 40 is provided at the preceding stage of the predictive controller 20. With this phase adjuster 40, the target command increment value is adjusted in phase and inputted into the predictive controller 20. The phase adjuster 40 is either a low-pass filter or a high-pass filter, or a delay device which delays a signal by a time set in the phase adjustment parameter. Any one of them can be arbitrarily selected.

FIG. 8 is a block diagram showing a structure of a third servo control apparatus which differs from the apparatus shown in FIG. 1 in that the predictive controller 20 is replaced by a position controller 30.

The position controller 30 adjusts the control input so that the target command obtained by integrating the target command increment value becomes coincided with the output of the controlled object. For example, the position controller 30 can be a PID controller which decides the control input by the operation of the proportional, integral, or derivative of the error of the target command and the motor position, or combination thereof.

The control input of the controlled object 1 outputted from the position controller 30 is inputted into the motor controller 3 of the controlled object 1.

FIG. 9 is a block diagram showing a structure of a fourth servo control apparatus which differs from the apparatus shown in FIG. 8 in that a phase adjuster 40 is added to the preceding stage of the position controller 30. This phase adjuster 40 adjusts the phase of the target command increment value, and the output is inputted into the position controller 30. The phase adjuster 40 is either a low-pass filter or a high-pass filter, or a delay device which delays a signal by a time set in the phase adjustment parameter. Any one of them can be arbitrarily selected.

Here, the position controller 30 can be arbitrarily constituted in accordance with the structure of the motor controller 3. For example, when the motor controller 3 performs a speed control of the motor 2, the position controller 30 can be constituted as a PID controller in which a speed command is sent to the motor controller 3 as a control input.

Moreover, when the motor controller 3 performs only a torque control, the position controller 30 can be constituted as a simple PID controller or a controller containing a speed controller therein.

Moreover, in the first to fourth embodiments, in cases where the motor 2 is a straight-moving type actuator, such as a linear motor, driven by a thrust command, the servo control apparatus of the same structure as mentioned above can be applied.

Since trackability can be improvable by compensating a feed-forward compensation signal as a compensation signal, a servo control apparatus according to the present invention can be applied to a machine which performs a synchronous control.

We claim:

1. A servo control apparatus for controlling a controlled object in response to a command, comprising:
a controller which receives a target command increment value which is an increment in a sampling period of a target command, and sends a control input to the controlled object such that the target command which is an integrated value of the target command increment value becomes coincident with an output of the controlled object; and
a compensation signal arithmetic unit which receives the target command increment value as an input, generates a compensation signal for decreasing a deviation an error of the target command and the output of the controlled object at the time of acceleration/deceleration, and sends the compensation signal to the controlled object.

2. The servo control apparatus as recited in claim 1, wherein the compensation signal arithmetic unit includes an inverse transfer function unit for receiving the target command increment value, the inverse transfer unit having an inverse transfer function characteristic of any standard low-pass filter, a subtracter which subtracts the target command increment value from an output of the inverse transfer function unit, and a multiplier which multiplies an output of the subtracter by an adjustment gain.

3. The servo control apparatus as recited in claim 1, wherein the compensation signal arithmetic unit includes a differentiator which differentiates the target command increment value, and a multiplier which multiplies an output of the differentiator by an adjustment gain.

4. The servo control apparatus as recited in claim 3, wherein the compensation signal arithmetic unit is equipped with a phase adjuster for performing a phase adjustment of an output of the multiplier.

5. The servo control apparatus as recited in claim 2, wherein the compensation signal arithmetic unit is equipped with a phase adjuster performing a phase adjustment at least one of input sides of the subtracter.

6. The servo control apparatus as recited in claim 1, further comprising a phase adjuster which sends a signal in which a phase adjustment of the target command increment value is performed to the controller.

7. The servo control apparatus as recited in claim 1, wherein the controller is a predictive controller which determines the control input such that an evaluation function on a deviation an error predicted value at a future time, a deviation an error, a control input, and a control input increment value becomes minimum.

8. The servo control apparatus as recited in claim 1, wherein the controller is a position controller which adjusts the control input so that the target command obtained by integrating the target command increment value becomes coincident with the output of the controlled object.

9. The servo control apparatus as recited in claim 1, wherein the controlled object includes a motor and a speed controller for controlling its speed, wherein the controller gives a speed command as a control input to the speed controller, and wherein the compensation signal arithmetic unit gives a feed-forward signal for compensating speed or torque as a compensation signal to the speed controller.

10. The servo control apparatus as recited in claim 1, wherein the controlled object includes a motor and a torque controller for controlling torque of the motor, wherein the controller gives a torque command to the torque controller as a control input, and wherein a compensation signal arithmetic unit gives a feed-forward signal for compensating torque as a compensation signal to the torque controller.

11. The servo control apparatus as recited in claim 9 or 10, wherein the motor is a straight-moving type motor.

12. The servo control apparatus as recited in any one of claims 4, 5, 6 and 15, wherein the phase adjuster is any one of a low-pass filter, a high-pass filter, and a delay device for delaying a signal by a time specified by a phase adjustment parameter.

13. The servo control apparatus as recited in claim 2, wherein the standard low-pass filter is a recursive filter or a non-recursive filter.

14. The servo control apparatus as recited in claim 8, wherein the position controller decides the control input by the target command obtained by integrating the target command increment value, any one of proportionality, integral and differential operation of an error with a position of the motor, or a combination thereof.

15. The servo control apparatus as recited in claim 2, wherein the compensation signal arithmetic unit is equipped with a phase adjuster for performing a phase adjustment of an output of the multiplier.
